(19) United States
(12) Patent Application Publication
(10) Pub. No.: US 2010/0138441 A1
(43) Pub. Date: Jun. 3, 2010

(54) METHOD FOR STORING TELEPHONE NUMBER BY AUTOMATICALLY ANALYZING MESSAGE AND MOBILE TERMINAL EXECUTING THE METHOD

(76) Inventor: Sang-Kyu Ryu, Gyeonggi-do (KR)

Correspondence Address: MAXON IP LLC, 46175 WESTLAKE DR., SUITE 410, POTOMAC FALLS, VA, 20165, US

(21) Appl. No.: 12/531,868

(22) PCT Filed: Aug. 6, 2008
(86) PCT No.: PCT/KR08/04557

§ 371 Date: Sep. 17, 2009

(30) Foreign Application Priority Data
Aug. 6, 2007 (KR) 10-2007-0078532

(51) Int. Cl. G06F 17/30; G06F 3/048

(52) U.S. Cl. 707/769; 707/E17.014; 715/764

(57) ABSTRACT

According to the present invention, a method for storing a phone number, which automatically compares a search keyword extracted from an address book stored in a mobile communication terminal with content of a received message and informs a user of phone number change or new phone number saving, includes (S21) extracting a search keyword for each individual address content from an address book of a mobile communication terminal; (S22) the mobile communication terminal receiving a message of a sender; (S23) searching the message content using the search keyword; (S24) in the case that the search keyword is searched from the message content, displaying ‘change phone number’ on the mobile communication terminal; and (S25) in the case that a user selects the ‘change phone number’, storing a new phone number extracted from the message content in place of a phone number of a corresponding address content.

### TECHNICAL FIELD

The present invention relates to a method for storing a phone number and a mobile communication terminal for performing the method, which automatically analyzes the content of a received message and determines whether or not the message is a message informing a changed phone number. If the message is determined as a message informing a changed phone number, a user is asked if the user will store a phone number of the message content. According to the user's selection, the phone number is stored in an address book in place of an existing phone number or as a new phone number.

### BACKGROUND ART

A telephone communication developed from a wired communication into a wireless mobile communication, and now we saw the age of one-person one-phone. With a rapid expansion of the mobile communication industry, the number of mobile communication terminal users is increasing geometrically.

It is reported that the mobile communication terminal users replace their terminals by new terminals every about 2 or 3 years, which involves a change of phone number. In the past, when a phone number of a user was changed, the user made a phone call to his/her friend and directly told his/her changed phone number. The inconvenience is that the user should repeat such a behavior to each of his/her friends.

To solve the problem, wired or wireless telephone communication providers developed a service for informing a changed phone number. This service provides an ARS (Automatic Route Selection) voice at a charge to inform a person who made a phone call to a former phone number of a new phone number. That is, a user informs a service provider of his/her former phone number, new phone number and service period, and applies for the service.

However, a user who is reluctant to pay for the service informs his/her friends of his/her changed phone number using SMS (Short Message Service) of his/her mobile communication terminal. In this case, a plurality of SMS can be sent to a plurality of receivers at the same time. Further, a format of SMS can be changed into a format of SMS for informing a changed phone number. The SMS for informing a changed phone number works in such a way that a sender writes a message containing name, former phone number and new phone number, sends the message to a receiver, and then a mobile communication terminal of the receiver analyzes a format of the message, in the case that the message is determined as an SMS for informing a changed phone number, informs the receiver of phone number change, and in the case that the receiver selects confirmation, stores the changed phone number. This requires application of a format other than a general SMS format to mobile communication terminals of a sender and a receiver. And, the sender has a limitation in the message content.

### DISCLOSURE OF INVENTION

### Technical Problem

The present invention is devised in consideration of the above-mentioned matters, and therefore, an object of the present invention is to provide a service for automatically storing a phone number, in which a sender writes a message informing a changed phone number in the same way as a general SMS, sends the message to a receiver, and then a mobile communication terminal of the receiver compares address book data with the message content, and in the case that the message is determined as a message informing a changed phone number, informs the receiver of phone number change or new phone number saving.

### Technical Solution

In order to achieve the above-mentioned objects, according to the present invention, a method for storing a phone number, which automatically compares a search keyword extracted from an address book stored in a mobile communication terminal with content of a received message and informs a user of phone number change or new phone number saving, includes (S21) extracting a search keyword for each individual address content from an address book of a mobile communication terminal; (S22) the mobile communication terminal receiving a message of a sender; (S23) searching the message content using the search keyword; (S24) in the case that the search keyword is searched from the message content, displaying ‘change phone number’ on the mobile communication terminal; and (S25) in the case that a user selects the ‘change phone number’, storing a new phone number extracted from the message content in place of a phone number of a corresponding address content.

According to another configuration of the present invention, a method for storing a phone number, which automatically compares an address book data stored in a mobile communication terminal with a search keyword extracted from content of a received message and informs a user of phone number change or new phone number saving, includes (S31) the mobile communication terminal receiving a message of a sender; (S32) analyzing the message content and extracting a search keyword; (S33) searching an address book of the mobile communication terminal using the search keyword to determine if the search keyword exists in each individual address content; (S34) in the case that the search keyword is searched from the address content, displaying ‘change phone number’ on the mobile communication terminal; and (S35) in the case that a user selects the ‘change phone number’, storing a new phone number extracted from the message content as a phone number of a corresponding address content.

Preferably, the search keyword includes at least one of name and phone number stored in the address book.

Further, the search keyword is (name), (phone number) or (name and phone number) extracted from the address book, and (name), (phone number) or (name and former phone number) to be changed is searched from the message content.

Furthermore, the method further includes, in the case that the search keyword is not searched from the message content, displaying ‘save new phone number’ on the mobile communication terminal; and in the case that the user selects the ‘save new phone number’, storing a new phone number extracted from the message content as a phone number of a new address content.

Preferably, in the case that at least two phone numbers exist in a target address content for phone number change or new phone number saving, the user selects a specific phone number of the at least two phone numbers.

Further, ‘change phone number’ or ‘save new phone number’ and the message content are displayed on the same page.

Preferably, in the case that the mobile communication terminal selects ‘change phone number’ or ‘save new phone number’ using a phone number in the message content, the mobile communication terminal displays an address book edit page to allow the user to directly edit at least one address content (including name, phone number, shortcut key, memo, e-mail and ringtone).

Additionally, a mobile communication terminal which receives a message, automatically analyzes the message content and informs a user of phone number change or new phone number saving, stores a program for performing the method including the above-mentioned steps S21 to S25 or S31 to S35.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic block diagram of a mobile communication terminal according to the present invention.

FIG. 2 is an internal configuration diagram of a mobile communication terminal for performing a method for storing a phone number according to a first embodiment of the present invention.

FIG. 3 is a flow chart of a method for storing a phone number performed by the mobile communication terminal of FIG. 2.

FIG. 4 is an internal configuration diagram of a mobile communication terminal for performing a method for storing a phone number according to a second embodiment of the present invention.

FIG. 5 is a flow chart of a method for storing a phone number performed by the mobile communication terminal of FIG. 4.

FIGS. 6 and 7 are example views of a display of a mobile communication terminal according to the present invention.

### BEST MODE FOR CARRYING OUT THE INVENTION

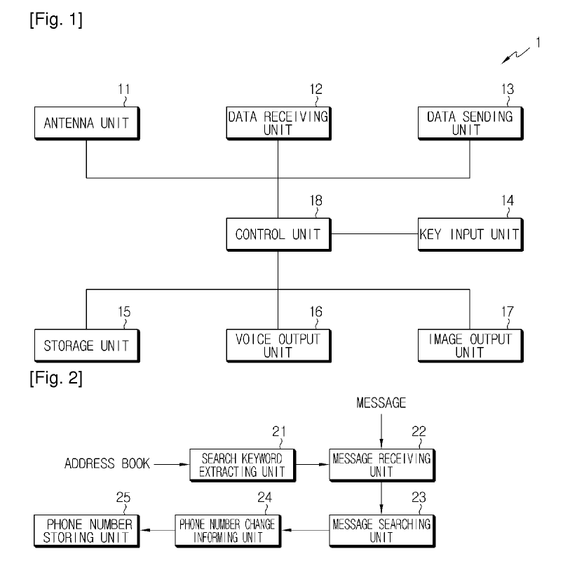

FIG. 1 is a schematic block diagram of a mobile communication terminal 1 according to the present invention.

The mobile communication terminal 1 according to the present invention includes an antenna unit 11 for receiving a signal, a data receiving unit 12 for receiving data through the antenna unit 11, a data sending unit 13 for sending data through the antenna unit 11, a key input unit 14 for receiving a keypad input from a user, a storage unit 15 for storing data, a voice output unit 16 for outputting voice through a speaker, an image output unit 17 for outputting an image to a user, and a control unit 18 for controlling the above-mentioned components 11 to 17.

The storage unit 15 stores a control program performing a method for storing a phone number according to the present invention. The program is automatically executed when the mobile communication terminal 1 is powered on, and is retained in a memory until the mobile communication terminal 1 is powered off.

The method for storing a phone number according to the present invention uses a message (SMS(Short Message Service), LMS(Long Message Service) or MMS(Multimedia Messaging Service)) received by the mobile communication terminal 1. The message of the present invention should include a new phone number for phone number change or new phone number saving that is to be stored in a receiver's mobile communication terminal, and may further include a name or a former phone number.

The mobile communication terminal 1 according to the present invention automatically analyzes the message content and determines whether or not the message is a message informing a changed phone number. The message content is analyzed to determine if continuous strings in the message include (name and new phone number) or (former phone number and new phone number). Each continuous string is separated by a space key, and means a string where characters, numbers or symbols are continuously arranged. According to the present invention, a message informing a changed phone number is written and sent, the message content is analyzed, and name and new phone number for phone number change or new phone number saving are extracted from the message content.

And, at least one of name and new phone number that can be extracted is set as a search keyword, and the message is semantically analyzed using the search keyword to determine whether or not the message is a message informing a changed phone number. According to the first embodiment of the present invention, a search keyword is extracted from continuous strings stored in an address book of a mobile communication terminal and the message content is searched by the extracted search keyword. And, according to the second embodiment, continuous strings of the message content are analyzed, a search keyword is extracted from the message and an address book is searched by the extracted search keyword. After search using the search keyword, in the case that the search keyword is detected, ‘change phone number’ is displayed. On the contrary, in the case that the search keyword is not detected, ‘save new phone number’ is displayed. Meanwhile, in the present invention, a sender can send to a receiver a message informing his/her changed phone number or a third party's changed phone number.

Then, □) name, □) phone number or □) name+phone number included in the message content is compared with names and phone numbers stored in the address book of the mobile communication terminal 1.

In the case that name, phone number or name+phone number included in the message content exists in the address book of the mobile communication terminal 1, ‘change phone number’ is displayed to ask if a receiver will change an existing phone number stored in the address book into the phone number included in the message content. And, in the case that name, phone number or name+phone number included in the message content does not exist in the address book of the mobile communication terminal 1, the phone number included in the message content is determined as a new phone number, and ‘save new phone number’ is displayed to ask if a receiver will store the phone number as a new phone number.

Hereinafter, configuration of the first and second embodiments of the present invention is described in detail with reference to the accompanying drawings.

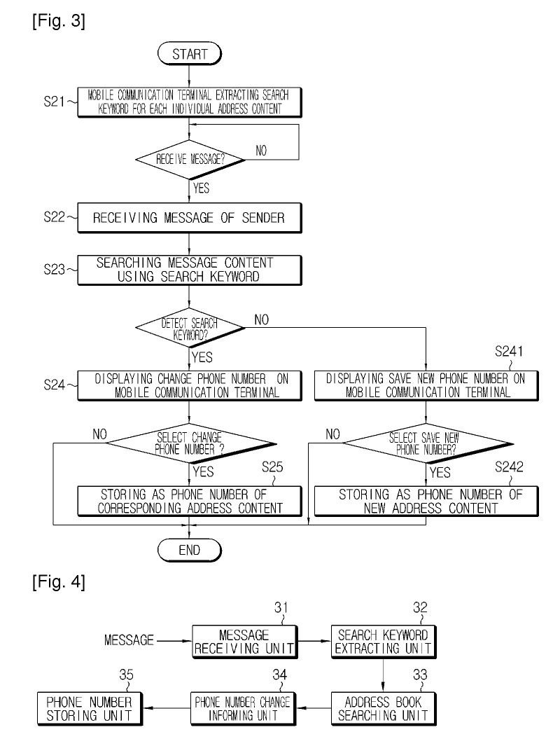

FIG. 2 is an internal configuration diagram of a mobile communication terminal 1 according to a first embodiment of the present invention, and FIG. 3 is a flow chart of a method for storing a phone number performed by the mobile communication terminal 1 of FIG. 2. The first embodiment of the present invention is described with reference to FIGS. 2 and 3.

The mobile communication terminal 1 according to a first embodiment of the present invention includes a search keyword extracting unit 21 for extracting a search keyword from an address book, a message receiving unit 22 for receiving a message, a message searching unit 23 for searching the message by the search keyword, a phone number change informing unit 24 for asking a user if the user will change an existing phone number, and a phone number storing unit 25 for storing a phone number in the address book according to the user's selection.

The search keyword extracting unit 21 extracts a search keyword from continuous strings stored in an address book of the mobile communication terminal 1 (S21). The address book is data stored in the mobile communication terminal 1, and whenever a contact is registered, an individual address content (item) is added. Typically, the address content includes name, e-mail, mobile phone number, telephone number, office phone number, fax number, birthday and memo. In the first embodiment, at least one of name and phone number is extracted as a search keyword for each contact. For example, in the case that a search keyword is extracted from an address book that stores phone numbers of ten contacts by name and mobile phone number, name and phone number of each contact are extracted, and thus, a total of twenty search keywords are extracted. If all phone numbers of each contact are extracted, the number of search keywords is increased. That is, a plurality of phone numbers of one contact may be extracted as a search keyword from his/her individual address content.

The message receiving unit 22 receives a message originated from a sender (S22).

The message searching unit 23 searches the message content by each search keyword extracted in the step S21 and determines if the search keyword is detected from the message (S23). Here, in the case that the search keyword is a phone number of an address book, because the search keyword is a continuous number string without a symbol of separation, the message searching unit 23 analyzes the message content, extracts a number string block, and removes the symbol of separation to convert into a continuous number string. For example, the message searching unit 23 extracts at least one continuous character string starting with a number and ending with a number in the message content, removes all symbols of separation from the extracted continuous character string to convert into a continuous number string, and compares the continuous number string with the search keyword.

When the search keyword is detected from the message content, the phone number change informing unit 24 displays the message content and ‘phone number change’ (S24). For example, in the case that name, or both of name and phone number (former phone number) is included in the message content, the method for storing a phone number according to the present invention can be applied. Meanwhile, in the present invention, when a page displaying the message content on the mobile communication terminal 1 is converted into another page, ‘change phone number’ or ‘save new phone number’ can be automatically displayed through design change.

Examples of message contents for phone number change are described as follows.

<Instance 1:□) name>

A name is searched from a message by a search keyword (name extracted from an address book), and in the case that a phone number included in the message is not equal to a phone number corresponding to the searched name stored in the address book, ‘change phone number’ is displayed.

Message example 1) “A phone number of John was changed into 010-XXX-XXXX”

example 2) “John, 010-XXX-XXXX”

<Instance 2:□) phone number>

In the case that a phone number is searched from a message containing two phone numbers by a search keyword (one phone number extracted from an address book), ‘change phone number’ is displayed that the phone number of the address book will be not changed into the searched phone number in the message but the other phone number that is not equal to the corresponding phone number stored in the address book.

Message example 5) “Hi. My phone number was changed from 010-000-0000 into 010-XXX-XXXX”

example 6) “010-000-0000 010-XXX-XXXX”

<Instance 3:□) name+phone number>

In the case that a name and a phone number is searched from a message containing two phone numbers by search keywords (name and one phone number extracted from an address book), ‘change phone number’ is displayed that the phone number searched from the message, equal to a phone number corresponding to the name extracted from the address book will be changed into the other phone number in the message.

Message example 3) “A phone number of John was changed from 010-000-0000 to 010-XXX-XXXX”

example 4) “John, 010-000-0000, 010-XXX-XXXX”

In the case that a user informed of phone number change selects the ‘change phone number’, the phone number storing unit 25 stores a new phone number extracted from the message in place of an existing phone number (S25). Here, phone number is stored in such a way that it is automatically converted into an edit page of a corresponding address content and in the case that there is no particulars to be edited, the user selects confirmation and stores the phone number as it is. That is, the user can directly edit an address content (for example, name, phone number, shortcut number, memo, e-mail and ringtone). For example, the user selects the type (mobile phone number, telephone number, office phone number or fax number) of a phone number prior to storing the phone number. In the case that the user is informed of phone number change but this is an erroneous informing, the user may press an end button to reject the phone number change.

Meanwhile, in the case that the search keyword is not detected from the message content in the step S24, this means that storing a new phone number not stored in the address book is requested, and thus the phone number change informing unit 24 displays the message content and ‘save new phone number’ (S241), and stores the phone number as a new address content according to the user's selection (S242). As mentioned above, phone number is stored in such a way that it is automatically converted into an edit page of a corresponding address content and allows the user to input a desired particular in an individual address content. During this step, the user can directly input a name or edit a phone number. Further, in the above-mentioned instance 2, the user can store each of two phone numbers or select and store any one of two phone numbers. In the same way as the above-mentioned phone number change, the user may press an end button to reject the new phone number saving.

FIG. 4 is an internal configuration diagram of a mobile communication terminal 1 according to a second embodiment of the present invention, and FIG. 5 is a flow chart of a method for storing a phone number performed by the mobile communication terminal 1 of FIG. 4. The second embodiment of the present invention is described with reference to FIGS. 4 and 5 as follows.

The mobile communication terminal 1 according to a second embodiment of the present invention includes a message receiving unit 31 for receiving a message, a search keyword extracting unit 32 for extracting a search keyword from the message content, an address book searching unit 33 for searching an address book using the search keyword, a phone number change informing unit 34 for asking a user if the user will change an existing phone number, and a phone number storing unit 35 for storing a phone number according to the user's selection.

The message receiving unit 31 receives a message originated from a sender (S31).

The search keyword extracting unit 32 extracts a search keyword from continuous character strings in the message content received by the mobile communication terminal 1 (S32). The search keyword includes □) name, □) phone number or □) name and phone number (former phone number). Therefore, at least one search keyword is extracted. However, the second embodiment arbitrarily extracts a name from the message content, which increases the number of search keywords, and thus the second embodiment has a lower processing efficiency than the first embodiment. For example, in the case that a sentence “SaYongJaEui JeonHwaBeonHo” is included in the message content, assuring that a unit of a search keyword for name is at least two syllables in Korean (Hangul), “SaYong”, “YongJa”, “JaEui”, “JeonHwa”, “HwaBeon” and “BeonHo” are extracted as a search keyword. Therefore, a search keyword may be limited to continuous two syllables in Hangul or the whole character string (for example: “SaYongJaEui” and “JeonHwaBeonHo”), or to only a phone number.

As another example, in the case of English language, a search keyword is extracted by unit of a word, and thus it is simpler to extract a search keyword in comparison with Korean language. Assuming that the message content includes a sentence (“User's phone number”) having the same meaning as the above-mentioned example. “User”, “User's”, “phone” and “number” are extracted as a search keyword through word recognition.

The address book searching unit 33 compares each search keyword extracted in the step S32 with an individual address content of the address book one by one, and determines if the search keyword exists in the individual address content of the address book (S33).

In the case that a search keyword is detected from an individual address content, the phone number change informing unit 34 displays the message content and ‘change phone number’ (S34). For example, in the case that a search keyword including name, phone number, or name and former phone number exists in an address content, the method for storing a phone number according to the present invention can be applied. The above-mentioned instances 1 to 3 can be applied to the second embodiment.

In the case that the user informed of phone number change selects ‘change phone number’, the phone number storing unit 35 stores a new phone number extracted from the message in place of an existing phone number (S35). Here, as mentioned above, phone number is stored in such a way that it is automatically converted into an edit page of a corresponding address content and allows the user to edit and store the individual address content.

Meanwhile, in the case that a search keyword is not detected from the address content in the step S34, this means that a message requesting to store a new phone number not stored in the address book is received, and thus the phone number change informing unit 34 displays the message content and ‘save new phone number’ (S341), and stores the phone number as a new address content according to the user's selection (S342). The phone number is stored in such a way that it is automatically converted into an address book edit page and allows the user to input other address contents.

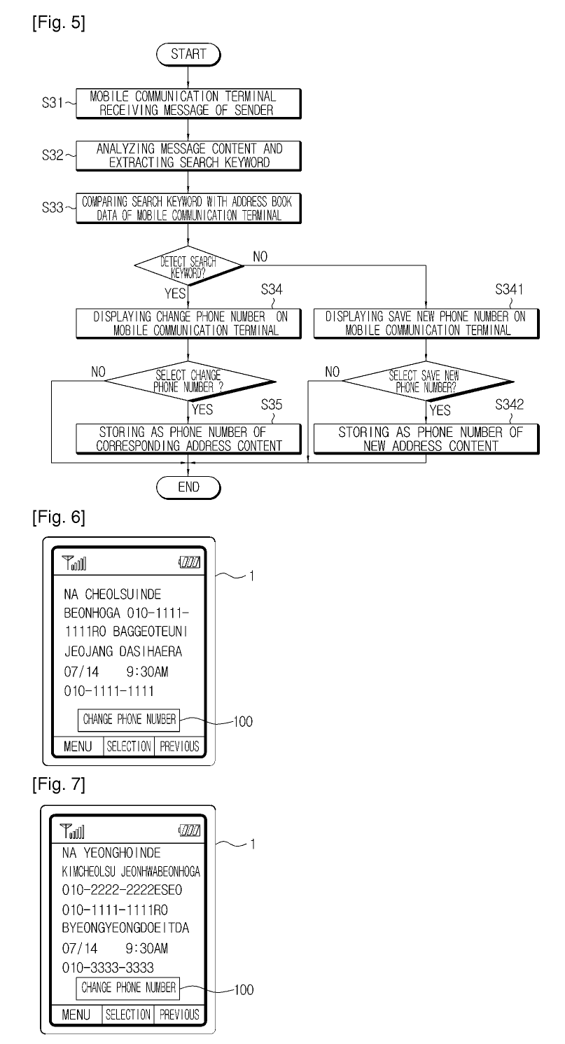

FIGS. 6 and 7 are example views of a display of the mobile communication terminal 1 according to the present invention.

FIG. 6 illustrates that a sender requests to store his/her changed phone number as described in <Instance 1>. According to the first embodiment, “CheolSu”, the name of a sender is one of search keywords extracted from an address book, and the mobile communication terminal 1 searches the message content using the search keyword “CheolSu”, detects the search keyword from the message content, and determines that CheolSu's phone number stored in the address book is not equal to a phone number included in the message content. Then, the mobile communication terminal 1 displays ‘change phone number’ 100 on a lower portion of its screen to inform a user of phone number change. According to the second embodiment, “CheolSu” is one of search keywords extracted from the message content. And, the mobile communication terminal 1 searches an address book using the search keyword “CheolSu”, determines that the search keyword “CheolSu” exists in the address book, and displays ‘change phone number’ 100. In the second embodiment, in the case that a search keyword of two syllables in Hangul is extracted from a total of 7 continuous character strings (for example: “Na”, “CheolSulnDe”, “BeonHoGa”, “010-1111-1111”, “BaGgeotEuNi”, “JeoJang”, “DaSiHaeRa”) separated by a space key in the message content of FIG. 6, a total of 12 search keywords (for example: “CheolSu”, “SuIn”, “InDe”, “BeonHo”, “HoGa”, “BaGgeot”, “GgeotEu”, “EuNi”, “JeoJang”, “DaSi”, “SiHae” and “HaeRa”) are extracted. In the case that “AhnCheolSu” and “KimCheolSu” (Name) exist in the address book, the mobile communication terminal 1 continuously informs the user of phone number change once per name, i.e. twice. In the same way, in the case that “CheolSu”, “SuIn” and “SiHae” are stored as a contact in the address book, the mobile communication terminal 1 continuously informs the user of phone number change three times so that the user can directly select a target contact for phone number change.

In the case of English language, the above-mentioned example is translated into “I'm CheolSu. My changed number is 010-1111-1111. Save the number”. In this case, a total of ten search keywords separated by a space key are extracted, for example “I'm”, “CheolSu”, “My”, “changed”, “number”, “is”, “010-1111-1111”, “Save”, “the” and “number”.

FIG. 7 illustrates that a third party requests to store another person's phone number as described in <Instance 3>. According to the first embodiment, “CheolSu” (name) and “010-2222-2222” (former phone number) each is one of search keywords extracted from an address book, and the mobile communication terminal 1 searches the message content using the search keywords “CheolSu” and “010-2222-2222”, and determines that the search keywords exist in the message content. Then, the mobile communication terminal 1 displays ‘change phone number’ 100 on a lower portion of its screen to inform a user of phone number change. According to the second embodiment, “CheolSu” and “010-2222-2222” among search keywords extracted from the message content are searched from address book data, and the mobile communication terminal 1 displays ‘change phone number’ 100.

Although FIGS. 6 and 7 show that an existing phone number stored in an address book is changed, in the case that a new phone number is additionally stored in the address book in the step S261 or S361, ‘save new phone number’ is displayed instead of ‘change phone number’ 100 to inform a user of new phone number saving. The message content of FIG. 6 has one name and one phone number, and thus it is not difficult to store the phone number in the address book as a phone number of a new contact. On the contrary, the message content of FIG. 7 has two phone numbers, and thus it is difficult to determine a target phone number to be stored. Therefore, preferably the user selects name and phone number on a page for storing a new phone number, and stores only any one contact or continuously stores both of two contacts.

Described above are the embodiments of the method for storing a phone number according to the present invention, which automatically analyzes the message content and informs of ‘change phone number’ or ‘save new phone number’, and the mobile communication terminal performing the method. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

A method for storing a phone number according to the present invention and a mobile communication terminal for performing the method use a conventional message format, and according to the present invention, when a sender or a third party sends a message informing a changed phone number, a mobile communication terminal of a receiver automatically analyzes semantically the message content, determines whether or not the message is a message informing a changed phone number, and informs the receiver of phone number change or new phone number saving.

1. A method for storing a phone number, which automatically compares a search keyword extracted from an address book stored in a mobile communication terminal with content of a received message and informs a user of phone number change or new phone number saving, the method comprising:
(S21) extracting a search keyword for each individual address content from an address book of a mobile communication terminal;
(S22) the mobile communication terminal receiving a message of a sender;
(S23) searching the message content using the search keyword;
(S24) in the case that the search keyword is searched from the message content, displaying ‘change phone number’ on the mobile communication terminal; and
(S25) in the case that a user selects the ‘change phone number’, storing a new phone number extracted from the message content in place of an existing phone number of a corresponding address content.

2. The method for storing a phone number according to claim 1,
wherein the search keyword includes at least one of name and phone number stored in the address book.

3. The method for storing a phone number according to claim 1,
wherein, in the step S24,
the search keyword is (name), (phone number) or (name and phone number) extracted from the address book, and
(name), (phone number) or (name and former phone number) for phone number change is searched from the message content.

4. The method for storing a phone number according to claim 1 or 3,
wherein the step S24 includes:
(S241) in the case that the search keyword is not searched from the message content, displaying ‘save new phone number’ on the mobile communication terminal; and
(S242) in the case that the user selects the ‘save new phone number’, storing a new phone number extracted from the message content as a phone number of a new address content.

5. A method for storing a phone number, which automatically compares an address book data stored in a mobile communication terminal with a search keyword extracted from content of a received message and informs a user of phone number change or new phone number saving, the method comprising:
(S31) the mobile communication terminal receiving a message of a sender;
(S32) analyzing the message content and extracting a search keyword;
(S33) searching an address book of the mobile communication terminal using the search keyword to determine if the search keyword exists in each individual address content;
(S34) in the case that the search keyword is searched from the address content, displaying ‘change phone number’ on the mobile communication terminal; and
(S35) in the case that a user selects the ‘change phone number’, storing a new phone number extracted from the message content as a phone number of a corresponding address content.

6. The method for storing a phone number according to claim 5,
wherein the search keyword includes at least one of name and phone number included in the message content.

7. The method for storing a phone number according to claim 5,
wherein, in the step S34,
the search keyword is (name), (phone number) or (name and former phone number) extracted from the message content, and
(name), (phone number) or (name and former phone number) for phone number change is searched from the address content.

8. The method for storing a phone number according to claim 5 or 7,
wherein the step S34 includes:
(S341) in the case that the search keyword is not searched from the address content, displaying ‘save new phone number’ on the mobile communication terminal; and
(S342) in the case that the user selects the ‘save new phone number’, storing a new phone number extracted from the message content as a phone number of a new address content.

9. The method for storing a phone number according to claim 1 or 5,
wherein, in the case that at least two phone numbers exist in a target address content for phone number change or new phone number saving, the user selects a specific phone number of the at least two phone numbers.

10. The method for storing a phone number according to claim 1 or 5,
wherein ‘change phone number’ or ‘save new phone number’ and the message content are displayed on the same page.

11. The method for storing a phone number according to claim 1 or 5,
wherein, in the case that the mobile communication terminal selects ‘change phone number’ or ‘save new phone number’ using a phone number in the message content, the mobile communication terminal displays an address book edit page to allow the user to directly edit at least one address content (including name, phone number, shortcut key, memo, e-mail and ringtone).

12. A mobile communication terminal which receives a message, automatically analyzes the message content and informs a user of phone number change or new phone number saving,
wherein the mobile communication terminal stores a program performing the method defined in claim 1 or 5.
